(19) United States
(12) Patent Application Publication
(10) Pub. No.: US 2007/0214805 A1
(43) Pub. Date: Sep. 20, 2007

(54) Onboard Regasification of LNG Using Ambient Air

(76) Inventors: Adrian Armstrong MacMillan, Santa Monica, CA (US); Solomon Aladja Faka, Woodland Hills, CA (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/559,144

(22) Filed: Nov. 13, 2006

Related U.S. Application Data
(60) Provisional application No. 60/782,282, filed on Mar. 15, 2006.

(51) Int. Cl. F17C 9/02; F17C 13/08

(52) U.S. Cl. 62/50.2; 62/53.2

(57) ABSTRACT

Offshore regasification of liquid natural gas (LNG) is provided onboard an LNG carrier vessel for delivery onshore as a gas. The LNG is regasified to natural gas aboard the LNG carrier vessel using ambient air as the primary source of heat for regasification. Condensed water that accumulates from the ambient air during the regasification of LNG is collected, and the collected condensed water is used as ballast for the LNG carrier vessel.

### CROSS-REFERENCE TO RELATED APPLICATION

This application claims priority from U.S. Provisional Patent Application Serial No. 60/782,282, entitled “Onboard Regasification of LNG” and filed Mar. 15, 2006. The disclosure of the above-identified patent application is incorporated herein by reference in its entirety.

### FIELD OF THE INVENTION

The present invention relates to a system for onboard regasification of liquefied natural gas (LNG) using ambient air vaporization. The present invention further relates particularly, though not exclusively to a system for utilizing condensed water collected during ambient air vaporization as ballast for an LNG carrier fitted with onboard regasification facilities.

### BACKGROUND TO THE INVENTION

Natural gas is the cleanest burning fossil fuel as it produces less emissions and pollutants than either coal or oil. Natural gas (“NG”) is routinely transported from one location to another location in its liquid state as “Liquefied Natural Gas (“LNG”). Liquefaction of the natural gas makes it more economical to transport as LNG occupies only about 1/600th of the volume that the same amount of natural gas does in its gaseous state. Transportation of LNG from one location to another is most commonly achieved using double-hulled ocean-going vessels with cryogenic storage capability referred to as “LNGCs”. LNG is typically stored in cryogenic storage tanks onboard the LNGC, the storage tanks being operated either at or slightly above atmospheric pressure. The majority of existing LNGCs have an LNG cargo storage capacity in the size range of 120,000 m³ to 150,000 m³, with some LNGCs having a storage capacity of up to 264,000 m³.

LNG is normally regasified to natural gas before distribution to end users through a pipeline or other distribution network at a temperature and pressure that meets the delivery requirements of the end users. Regasification of the LNG is most commonly achieved by raising the temperature of the LNG above the LNG boiling point for a given pressure. It is common for an LNGC to receive its cargo of LNG at an “export terminal” located in one country and then sail across the ocean to deliver its cargo at an “import terminal” located in another country. Upon arrival at the import terminal, the LNGC traditionally berths at a pier or jetty and offloads the LNG as a liquid to an onshore storage and regasification facility located at the import terminal. The onshore regasification facility typically comprises a plurality of heat exchangers or vaporizers, pumps and compressors. Such onshore storage and regasification facilities are typically large and the costs associated with building and operating such facilities are significant.

Recently, public concern over the costs and sovereign risk associated with construction of onshore regasification facilities has led to the building of offshore regasification terminals which are removed from populated areas and onshore activities. Various offshore terminals with different configurations and combinations have been proposed. For example, U.S. Pat. No. 6,089,022 describes a system and a method for regasifying LNG aboard a carrier vessel before the re-vaporized natural gas is transferred to shore for delivery to an onshore facility. The LNG is regasified using seawater taken from the body of water surrounding the carrier vessel which is flowed through a regasification facility that is fitted to and thus travels with the carrier vessel all of the way from the export terminal to the import terminal. The seawater exchanges heat with the LNG to vaporize the LNG to natural gas and the cooled seawater is returned to the body of water surrounding the carrier vessel. Seawater is an inexpensive source of intermediate fluid for LNG vaporisation but has become less attractive due to environmental concerns. The main concern is due to the presence of organisms in the seawater which may well be killed and the environmental impact of cooled seawater returned to the marine environment.

An object of the present invention is to provide a more environmentally friendly alternative to known offshore LNG regasification operations.

### SUMMARY OF THE INVENTION

According to one aspect of the present invention there is provided a method for offshore regasification of liquid natural gas (LNG) onboard an LNG carrier vessel for delivery onshore as a gas, the method comprising:
a) regasifying LNG to natural gas aboard the LNG carrier vessel using ambient air as the primary source of heat for regasification;
b) collecting condensed water that accumulates during step a); and,
c) using the collected condensed water from step b) as ballast for the LNG carrier vessel.

In one embodiment, step a) comprises direct heat exchange between the ambient air and the LNG. In an alternative embodiment, step a) comprises heat exchange between ambient air and an intermediate fluid to produce a heated intermediate fluid and the heated intermediate fluid exchanges heat with the LNG to regasify the LNG.

To improve heat exchange efficiency, heat exchange between the ambient air and the regasification facility may be encouraged through use of forced draft fans.

The method of offshore regasification may further comprise the step of transferring the regasified natural gas to an onshore gas distribution facility for delivery to an end user. In one embodiment, the regasified natural gas is transferred to a subsea pipeline through a submersible, disconnectable mooring buoy locatable within a recess disposed within a portion of the hull of the LNG carrier vessel.

According to a second aspect of the preset invention there is provided an LNG carrier vessel having a ballast tank for holding ballast water and a storage tank for holding LNG to be regasified, the LNG carrier vessel comprising:
a regasification facility onboard the LNG carrier vessel using ambient air as the primary source of heat for vaporizing LNG to natural gas; and,
a condensed water collection system for collecting the condensed water from the regasification facility for transferring the condensed water to the ballast tank of the LNG carrier vessel.

In one embodiment, the regasification facility includes a closed loop heat exchanger for heating an intermediate fluid using ambient air as the primary source of heat and a vaporizer for regasifying LNG using the heated intermediate fluid. In an alternative embodiment, the regasification facility includes a vaporizer for direct heating of the LNG using ambient air.

To further encourage heat exchange between ambient air and the regasification facility, the LNG carrier vessel may further comprise forced draft fans.

In one embodiment, the LNG carrier vessel further comprises a recess disposed within the hull and towards the bow of the RLNGC for receiving a submersible, disconnectable mooring buoy for mooring the RLNGC during regasification.

### BRIEF DESCRIPTION OF THE DRAWINGS

In order to facilitate a more detailed understanding of the nature of the invention several embodiments of the present invention will now be described in detail, by way of example only, with reference to the accompanying drawings, in which:

FIG. 1 is a schematic side view of the RLNGC moored at a turret mooring buoy through which the natural gas is from the onboard regasification facility is transferred through a marine rise associated with a sub-sea pipeline to shore;

FIG. 2 is a flow chart illustrating one embodiment of the onboard regasification facility in which ambient air exchanges heat with an intermediate fluid and the intermediate fluid exchanges heat with the LNG to form natural gas; and,

FIG. 3 is a flow chart illustrating an alternative embodiment of the onboard regasification facility in which ambient air exchanges heat directly with LNG to form natural gas.

### DETAILED DESCRIPTION OF PREFERRED EMBODIMENTS

Particular embodiments of the system for offshore regasification of LNG using ambient air as the primary source of heat for vaporization are now described. The terminology used herein is for the purpose of describing particular embodiments only, and is not intended to limit the scope of the present invention. Unless defined otherwise, all technical and scientific terms used herein have the same meanings as commonly understood by one of ordinary skill in the art to which this invention belongs.

Throughout this specification the term “RLNGC” refers to a self-propelled vessel, ship or LNG carrier provided an onboard regasification facility which is used to convert LNG to natural gas. The RLNGC can be a modified ocean-going LNG vessel or a vessel that is custom or purpose built to include the onboard regasification facility.

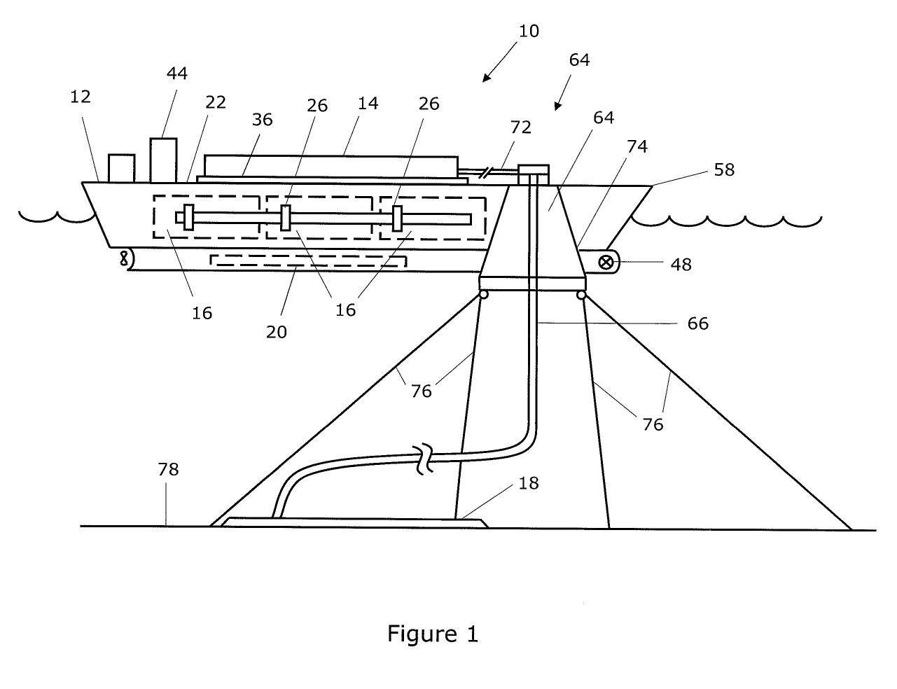

A first embodiment of the system of the present invention is now described with reference to FIG. 1. In this first embodiment, the system 10 includes an RLNGC 12 provided with an onboard regasification facility 14 for regasifying LNG that is stored aboard the RLNGC in one or more cryogenic storage tanks 16. The natural gas produced using the onboard regasification facility 14 is transferred to a sub-sea pipeline 18 used to deliver the natural gas to an onshore gas distribution facility (not shown). The onboard regasification facility 14 uses ambient air as the primary source of heat for regasification of the LNG and during this process, water condenses out of the ambient air. This water condensate is collected and stored in the ballast tank 20 of the RLNGC 12 to provide ballast for the RLNGC 12 as regasification of the LNG stored onboard the RLNGC 12 continues to reduce the cargo being carried by the RLNGC 12.

In one embodiment of the present invention, LNG is stored aboard the RLNGC in 4 or 7 prismatic self-supporting cryogenic storage tanks, each storage tank having a gross storage capacity in the range of 30,000 to 50,000 m³. The RLNGC 12 has a supporting hull structure capable of withstanding the loads imposed from intermediate filling levels in the storage tanks when the RLNGC is subject to harsh, multi-directional environmental conditions. The second storage tank(s) onboard the RLNGC are robust to or reduce sloshing of the LNG when the storage tanks are partly filled or when the RLNGC is riding out a storm whilst moored. To reduce the effects of sloshing, the storage tank(s) 16 are provided with a plurality of internal baffles or a reinforced membrane. The use of membrane tanks allows more space on the deck 22 of the RLNGC 12 for the regasification facility 14. Self supporting spherical cryogenic storage tanks, for example Moss type tanks, are not considered to be suitable if the RLNGC 12 is fitted with an onboard regasification facility 14, as Moss tanks reduce the deck area available to position the regasification facility 14 on the deck of the RLNGC 12.

A high pressure onboard piping system 24 is used to convey LNG from the storage tanks 16 to the regasification facility 14 via at least one cryogenic pump 26. Examples of suitable cryogenic pumps include a centrifugal pump, a positive-displacement pumps, a screw pump, a velocity-head pump, a rotary pump, a gear pump, a plunger pump, a piston pump, a vane pump, a radial-plunger pumps, a swash-plate pump, a smooth flow pump, a pulsating flow pump, or other pumps that meet the discharge head and flow rate requirements of the vaporizers. The capacity of the pump is selected based upon the type and quantity of vaporizers installed, the surface area and efficiency of the vaporizers and the degree of redundancy desired. They are also sized such that the RLNGC 12 can discharge its cargo at a conventional import terminal at a rate of 10,000 m³/hr (nominal) with a peak of 16,000 m³/hr.

The regasification facility 14 includes at least one vaporizer 30 for regasifying LNG to natural gas. To provide sufficient surface area for heat exchange, the vaporizer 30 may be one of a plurality of vaporizers arranged in a variety of configurations, for example in series or in banks. The vaporizer can equally be a shell and tube heat exchanger, a finned tube heat exchanger, a bent-tube fixed-tube-sheet exchanger, a spiral tube exchanger, a plate-type heat exchanger, or any other heat exchanger commonly known by those skilled in the art that meets the temperature, volumetric and heat absorption requirements for quantity of LNG to be regasified.

Using the method of the present invention, the primary source of heat used for onboard regasification is ambient air. Ambient air is used as the primary source of heat for vaporization to reduce environmental impact and to keep emissions of nitrous oxide, sulphur dioxide, carbon dioxide, volatile organic compounds and particulate matter to a minimum. The temperature and relative humidity of the ambient air can vary according to the seasons or the type of climate in the location at which the RLNGC is moored.

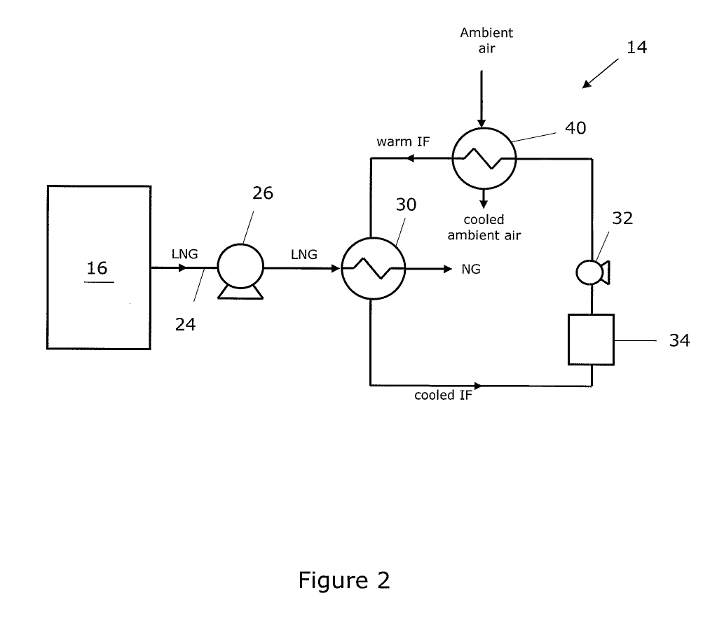

In the embodiment illustrated in FIG. 2, LNG is fed to the vaporizer 30 and is regasified to natural gas by heat exchange with an intermediate fluid. Suitable intermediate fluids include one or more of the following: glycol, propane, formate, salt water or fresh water or any other fluid with an acceptable heat capacity and boiling point that is commonly known to a person skilled in the art. In this embodiment, the intermediate fluid is heated by exchanging heat with the ambient air and the heated intermediate fluid is then pumped to the vaporizer 30 in which the LNG is regasified to natural gas through heat exchange with the heated intermediate fluid. The cooled intermediate fluid which exits the vaporizer 30 is directed to a surge tank 34 and then pumped back to the ambient air heat exchanger 40 using intermediate fluid pump 32.

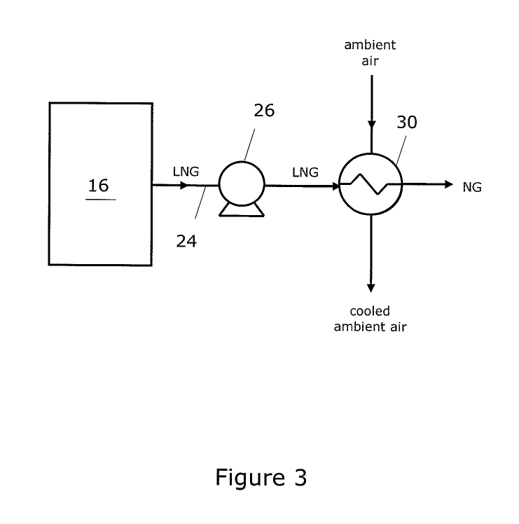

An alternative embodiment of the onboard regasification facility is illustrated in FIG. 3, in which LNG is fed to the tube side of the vaporizer 30 and regasified to natural gas by heat exchange with ambient air on the shell side of the vaporizer 30.

Heat transfer between the ambient air and the LNG or between the ambient air and the intermediate fluid can be assisted through the use of forced draft fans 44 arranged to direct the flow of air towards the vaporizers 30 (FIG. 3) or the heat exchangers 40 (FIG. 2).

Whilst only one vaporizer 30 and only one heat exchanger 40 are shown in FIG. 2 for illustrative purposes, it is to be understood that the onboard regasification facility may comprise any number of vaporizers and heat exchangers arranged in parallel or series depending on the capacity of each vaporizer and the quantity of LNG being regasified. It is also advantageous in some circumstances to design the onboard regasification facility 14 to include redundancy to allow for routine maintenance or repair or to provide for defrosting cycles (if required, depending in part on the relative humidity and temperature of the ambient air at a given location). The vaporizers, heat exchangers and fans (if used) are designed to withstand the structural loads associated with being disposed on the deck of the RLNGC during transit of the vessel at sea including the loads associated with motions and possibly green water loads as well as the loads experienced whilst the RLNGC is moored offshore during regasification.

Using ambient air to provide the heat for LNG vaporization generates a pure water condensate as a by-product, the quantity of which depends on the relative humidity of the ambient air being cooled. The water condensate collected in the condensate collection trap 36 is substantially fresh water. In the embodiment illustrated in FIG. 2, water condensate is collected from the ambient air heat exchanger 40. In the embodiment illustrated in FIG. 3, water condensate is collected when the vaporizer 30 is taken off duty or subjected to a defrosting operation.

The water condensate generated through use of ambient air as the primary source of heat in the regasification facility 14 is collected using a water condensate collection trap 36 and transferred to the RLNGC's ballast tanks 20. Use of the water condensate in this way reduces the volume of sea water which would otherwise be used to ballast the RLNGC 12 as the mass of LNG onboard the vessel is reduced through regasification. This also removes the need to otherwise discharge or dispose of the condensate water which reduces the impact on the environment.

The volume of water condensate produced during onboard regasification of LNG using ambient air as the primary source of heat may be a portion of the total ballast water capacity for the RLNGC, as the actual volume and rate of water condensate generated varies the ambient conditions and regasification rates.

Table 1 below shows the water produced at the design ambient conditions, and at a temperature and humidity greater than the design condition. The volumes shown in this table are less than the required ballast water intake volume over the same period.

TABLE 1

| Gas Send-out | | Relative | Water | |
|---|---|---|---|---|
| Rate | Temperature | Humidity | Condensate Rate | |
| (MMSCFD) | (° F.) | (%) | m3/hr | US GPM |
| 1100 | 60 | 60 | 125 | 550 |
| 1100 | 80 | 100 | 162 | 715 |

By way of example, at design ambient conditions, of 60° F. (16° C.) and 60% relative humidity, and a maximum send out rate of 1100 MMSCFD, the rate of water condensation is approximately 125 m³/hr (550 US gallons/minute). At the maximum send out rate of 1100 MMSCFD, and ambient conditions of 80° F. (27° C.) and 100% relative humidity, the condensed water rate is approximately 162 m³/hr (715 US gallons/minute). This condensate is collected and directed to the ship's ballast tanks.

Ambient air may be used as the only source of heat for regasification of the LNG or can be used as the primary source of heat in combination with a secondary source or a number of secondary sources of heat. When a secondary source of heat is used, this can supplement heating for direct regasification of the LNG or to supplement heating of the intermediate fluid. When ambient air is used as the primary source of heat for the vaporizers 30 (with reference to the embodiment illustrated in FIG. 3), the secondary source of heat may be used to reduce the effects of freezing up of the vaporizers to reduce or eliminate defrosting and to mitigate the impact of low ambient temperatures on system capacity. Suitable secondary sources of heat include waste heat recovery from the propulsion system, steam from a boiler or other source, a submerged combustion vaporizer, solar energy, electric heaters using the excess electric generating capacity of the propulsion plant when the RLNGC is moored, exhaust gas heat exchangers fitted to the combustion exhausts of the diesel engines and gas turbines, or natural gas fired hot water or thermal oil heaters. The secondary source of heat can equally be generated by direct firing when additional heat is needed.

With reference to the embodiment illustrated in FIG. 1, the RLNGC 12 is designed or retrofitted to include a recess or “moonpool” 74 to facilitate docking of the RLNGC 12 with an internal turret mooring buoy 64. The second LNG Carrier 14 connects to the mooring buoy 64 in a manner that permits the RLNGC 14 to weathervane around the turret mooring buoy 64. An example of a suitable type of turret mooring systems is described in U.S. Pat. No. 6,688,114, the contents of which are incorporated herein by reference. The mooring buoy 64 is moored by anchor lines 76 to the seabed 78. The mooring buoy 64 is provided with one or more marine risers 66 which serve as conduits for the delivery of regasified natural gas through the mooring buoy 64 to the sub sea pipeline 18. Fluid-tight connections are made between the inlet of the marine risers 66 and a gas delivery line 72 to allow the transfer of natural gas from the regasification facility 14 onboard the second LNG Carrier 14 to the marine riser. A rigid arm connection over the bow 58 of the RLNGC to a single point or a riser turret mooring could equally be used, but is not preferred.

To allow the RLNGC 12 to pick up the mooring buoy 64 without assistance, the RLNGC 12 is highly manoeuvrable. In one embodiment, the RLNGC 12 is provided with directionally controlled propellers which are capable of 360 degree rotation. The RLNGC 12 has a propulsion system which comprises twin screw, fixed pitch propellers with transverse thrusters located both forward and aft that provide the RLNGC 12 with mooring and position capability.

Where prevailing weather is highly directional, spread mooring can be used as an alternative. Such locations are not common.

A key advantage of the use of a RLNGC 12 over a permanently moored offshore storage structure such as a gravity-based structure or a barge, is that the RLNGC 12 is capable of travelling under its own power offshore or up and down a coastline to avoid extreme weather conditions or to avoid a threat of terrorism or to transit to a dockyard or to transit to another LNG import or export terminal. In this event, the RLNGC 12 may do so with or without LNG stored onboard during this journey. Similarly, if demand for gas no longer exists at a particular location, the RLNGC 12 can sail under its own power to another location where demand is higher.

Now that several embodiments of the invention have been described in detail, it will be apparent to persons skilled in the relevant art that numerous variations and modifications can be made without departing from the basic inventive concepts. All such modifications and variations are considered to be within the scope of the present invention, the nature of which is to be determined from the foregoing description and the appended claims.

All of the patents cited in this specification, are herein incorporated by reference. It will be clearly understood that, although a number of prior art publications are referred to herein, this reference does not constitute an admission that any of these documents forms part of the common general knowledge in the art, in Australia or in any other country. In the summary of the invention, the description and claims which follow, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

What is claimed:

1. A method for offshore regasification of liquid natural gas (LNG) onboard an LNG carrier vessel for delivery onshore as a gas, the method comprising:
a) regasifying LNG to natural gas aboard the LNG carrier vessel using ambient air as the primary source of-heat for regasification;
b) collecting condensed water that accumulates from the ambient air during step a); and,
c) using the collected condensed water from step b) as ballast for the LNG carrier vessel.

2. The method of offshore regasification of claim 1, wherein step a) comprises direct heat exchange between the ambient air and the LNG.

3. The method of offshore regasification of claim 1, wherein step a) comprises heat exchange between ambient air and an intermediate fluid to produce a heated intermediate fluid and the heated intermediate fluid exchanges heat with the LNG to regasify the LNG.

4. The method of offshore regasification of claim 1, wherein heat exchange between the ambient air and the regasification facility is encouraged through use of forced draft fans.

5. The method of offshore regasification of claim 1, further comprising the step of transferring the regasified natural gas to an onshore gas distribution facility for delivery to an end user.

6. The method of offshore regasification of claim 1, wherein the regasified natural gas is transferred to a subsea pipeline through a submersible, disconnectable mooring buoy locatable within a recess disposed within a portion of the hull of the LNG carrier vessel.

7. An LNG carrier vessel including a ballast tank to hold ballast water and a storage tank to hold LNG to be regasified, the LNG carrier vessel comprising:
a regasification facility onboard the LNG carrier vessel using ambient air as the primary source of heat for vaporizing LNG to natural gas; and,
a condensed water collection system to collect the condensed water from the regasification facility and to transfer the condensed water to the ballast tank of the LNG carrier vessel.

8. The LNG carrier vessel of claim 7, wherein the regasification facility includes a vaporizer to provide direct heating of the LNG using ambient air.

9. The LNG carrier vessel of claim 7, wherein the regasification facility includes a closed loop heat exchanger to heat an intermediate fluid using ambient air as the primary source of heat and a vaporizer to regasify LNG using the heated intermediate fluid.

10. The LNG carrier vessel of claim 7, further comprising forced draft fans to encourage heat exchange between ambient air and the regasification facility.

11. The LNG carrier vessel of claim 7, further comprising a recess disposed within the hull and toward the bow of the RLNGC to receive a submersible, disconnectable mooring buoy for mooring the RLNGC during regasification.
